(19) United States
(12) Patent Application Publication
(10) Pub. No.: US 2024/0387962 A1
(43) Pub. Date: Nov. 21, 2024

(54) FUSE THAT INTERACTS WITH LEAKED BATTERY ELECTROLYTE TO BLOW FUSE

(71) Applicant: LENOVO (SINGAPORE) PTE. LTD., SINGAPORE (SG)

(72) Inventors: Arnold Weksler, Morrisville, NC (US); Bouziane Yebka, Morrisville, NC (US); John C. Mese, Morrisville, NC (US); Nathan Peterson, Morrisville, NC (US); Russell S. VanBlon, Morrisville, NC (US); Mark Delaney, Morrisville, NC (US)

(21) Appl. No.: 18/320,908

(22) Filed: May 19, 2023

(51) Int. Cl. H01M 50/574; G01M 3/04; H01H 85/32; H01M 10/48; H02H 3/04

(52) U.S. Cl. CPC H01M 50/574; G01M 3/045; H01H 85/32; H01M 10/488; H02H 3/046

(57) ABSTRACT

In one aspect, an apparatus includes a battery. The battery includes at least one battery cell and a casing that houses the at least one battery cell. The apparatus also includes a fuse. The fuse includes material configured to dissolve based on chemical interaction with matter from the at least one battery cell.

### FIELD

The disclosure below relates to technically inventive, non-routine solutions that produce concrete technical improvements. In particular, the disclosure below relates to batteries with a fuse that interacts with leaked battery electrolyte to blow the fuse.

### BACKGROUND

As recognized herein, batteries might begin to leak toxic matter but still have enough voltage to continue powering the device in whey they are disposed. In the meantime, the user might not know about the leak, which is particularly true for devices that do not monitor their own battery health, such as flashlights, remote controls, radios, and many other “dummy” household devices. In such situations, the user might not discover the leak until after the device stops working and only then discover that the leak has permanently damaged the device itself (e.g., damaged the device's electrical contacts so that the device can no longer be powered by healthy replacement batteries). Not only that, but when attempting to remove the leaking battery, the user might be exposed to harmful agents that have leaked from the battery, compromising the user's health. There are currently no adequate solutions to the foregoing technological problems.

### SUMMARY

Accordingly, in one aspect, an apparatus includes a battery. The battery includes at least one battery cell and a casing housing the at least one battery cell. The apparatus also includes a fuse. The fuse includes material configured to dissolve based on chemical interaction with matter from the at least one battery cell.

In certain example implementations, based on the chemical interaction the fuse may blow to break a current path inside the battery. Also in certain example implementations, based on the chemical interaction the fuse may blow to break a current path between the battery and a device in which the battery is disposed. The apparatus might even include the device itself.

Also in various examples, the fuse(s) may be disposed internal to the casing and/or disposed external to the casing.

Still further, if desired, the apparatus may include a device that houses the battery, where the fuse may be disposed in the device but not on the battery.

What's more, in certain example implementations, the apparatus may be configured to provide a notification responsive to the fuse being blown. The notification may include a light emitting diode (LED) on the battery no longer emitting light, where the LED was emitting light prior to the fuse being blown. As other examples, the notification(s) may include a graphical element presented on a display of a device in which the battery is disposed, audio indicating that the fuse has blown, and/or the illuminating of a light emitting diode (LED) (e.g., where the LED may not emit light prior to the fuse being blown and where the LED does not form part of a computer monitor).

In various examples, the material itself may include aluminum, while the matter may include sulfuric acid.

In another aspect, an apparatus includes a fuse. The fuse includes material configured to dissolve based on chemical interaction with matter from at least one battery cell.

In certain examples, the material may include aluminum, and the matter may include sulfuric acid.

Also in certain examples, the material may include nylon and/or nitrite in a first layer of the material, aluminum in a second layer of the material, a substance in a third layer of the material, and aluminum in a fourth layer of the material. The first, second, third, and fourth layers may be different from each other. The first layer may be an outer layer, the second layer may be adjacent to and between the first and third layers, the third layer may be adjacent to and between the second and fourth layers, and the fourth layer may be both adjacent to the third layer and spaced from the second layer by the third layer. The substance of the third layer may include nylon, nitrite, and/or cellulose. Additionally, if desired the material may have a thickness between 10 microns and 100 microns.

In still another aspect, a method includes providing a battery comprising at least one battery cell and providing a fuse. The fuse includes material configured to dissolve based on chemical interaction with electrolyte from the at least one battery cell.

The details of present principles, both as to their structure and operation, can best be understood in reference to the accompanying drawings, in which like reference numerals refer to like parts and in which:

### BRIEF DESCRIPTION OF THE DRAWINGS

FIG. 1 is a block diagram of an example system that houses a battery and is powered by the battery consistent with present principles;

FIG. 2 shows a perspective view of example fuses that may be used consistent with present principles;

FIGS. 3A-3D show top plan views of example fuses that may be used consistent with present principles;

FIG. 4 illustrates various steps for manufacturing/assembly of an example fuse consistent with present principles;

FIG. 5A a longitudinal cross-sectional view of an example fuse consistent with present principles;

FIG. 5B shows the fuse of FIG. 5A in a perspective view;

FIG. 6A shows a longitudinal cross-sectional view of another example fuse consistent with present principles;

FIG. 6B shows the fuse of FIG. 6A in perspective view;

FIG. 7 shows a longitudinal cross-sectional view of yet another example fuse consistent with present principles;

FIG. 8 shows a longitudinal cross-sectional view of an example fuse once blown consistent with present principles;

FIGS. 9-11 show side elevational views of lead acid batteries with example fuses at various positions with respect to the batteries consistent with present principles;

FIG. 12 shows a perspective view of an example device providing notifications about a blown fuse consistent with present principles;

FIG. 13 shows a longitudinal cross-sectional view of example material consistent with present principles that may be wrapped around a battery and dissolve upon contact with internal matter from the battery consistent with present principles;

FIG. 14 shows a perspective view of a cylindrical battery with the example material wrapped around the battery's exterior consistent with present principles;

FIG. 15 shows the cylindrical battery with part of the example material already dissolved;

FIG. 16 shows a chart of example fuse/wrap materials that may or may not be soluble for battery electrolyte of various chemistries consistent with present principles; and

FIGS. 17A and 17B show various stages of assembly/disassembly of a lead acid vehicle battery for illustration consistent with present principles.

### DETAILED DESCRIPTION

Among other things, the detailed description below deals with making a user aware of battery leakage, including for devices that do not monitor battery health themselves. For example, present principles may be used for batteries in flashlights, television remote controls and other types of remote controls such as garage door openers or vehicle key fobs, AM/FM/XM radios, home cooking appliances, Internet of things (IoT) devices, lanterns, etc. However, present principles may also be used for batteries in smart devices that monitor battery health at the battery management unit (BMU) level, CPU level, etc. as well.

In any case, apparatuses and methods are disclosed to help a user recognize a battery leak so the user may replace the battery sooner. This, in turn, helps to avoid electrical shorts and additional (and sometimes permanent) damage to the device, like damage to the device's electrical contacts themselves, while also improving user safety in handling a malfunctioning battery. Thus, although sometimes batteries might begin leaking and still have sufficient voltage to continue powering the device itself, using principles set forth below, the user may be made aware of the malfunction sooner to prompt the user to take action and therefore prevent this leaking from worsening while the device itself might still otherwise be powered. Principles set forth below may therefore improve on existing “dumb” batteries/household devices that do not have the capability to do active battery monitoring themselves (and still also provide improvements to devices that may in fact do so).

Accordingly, in one example implementation, a battery may be wrapped with a very thin layer of material at the positive and negative terminals of the battery as well as at other portions of the battery's casing. As the leak begins, the battery leak will cause a chemical reaction with the material that will dissolve the material to one or both of break/disconnect a current path being used by the battery to power the device itself and/or reveal another color underneath the material to serve as a notification to the user to take action.

Additionally or alternatively, this material may be incorporated into a fuse that blows when the material dissolves, breaking a current path in the process and rendering the battery inoperable. The fuse may be placed in the current path, whether on the top, bottom, or side of the battery, or wherever battery leaks are known to occur in that particular type/model of battery.

Present principles may be used for batteries with lead acid battery chemistry, including lead acid batteries built with several individual cells containing layers of lead alloy plates immersed in an electrolyte solution and made of 35% Sulfuric acid (H2SO4) and 65% water (as an example). However, further note that the fuse may be configured for chemical interaction with electrolyte from other types of batteries as well, including alkaline-based and/or lithium-ion based batteries.

Prior to delving further into the details of the instant techniques, note with respect to any computer systems discussed herein that a system may include server and client components connected over a network such that data may be exchanged between the client and server components. The client components may include one or more computing devices, including televisions (e.g., smart TVs, Internet-enabled TVs), computers such as desktops, laptops, and tablet computers, so-called convertible devices (e.g., having a tablet configuration and laptop configuration), and other mobile devices including smartphones. These client devices may employ, as non-limiting examples, operating systems from Apple Inc. of Cupertino, CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, control lines, registers, and shift registers. Moreover, any logical blocks, modules, and circuits described herein can be implemented or performed with a system processor, a digital signal processor (DSP), a field programmable gate array (FPGA), or other programmable logic devices such as an application-specific integrated circuit (ASIC), discrete gate or transistor logic, discrete hardware components, or any combination thereof designed to perform the functions described herein. A processor can also be implemented by a controller or state machine, or a combination of computing devices. Thus, the methods herein may be implemented as software instructions executed by a processor, suitably configured application-specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, solid state drive, CD ROM or Flash drive). The software code instructions may also be downloaded over the Internet. Accordingly, it is to be understood that although a software application for undertaking present principles may be vended with a device such as a system 100 described below, such an application may also be downloaded from a server to a device over a network such as the Internet.

Software modules and/or applications described through flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic, when implemented in software, can be written in an appropriate language such as but not limited to a hypertext markup language (HTML)-5, Java®/JavaScript, C# or C++, and can be stored on or transmitted from a computer-readable storage medium such as a hard disk drive (HDD) or solid-state drive (SSD), a random access memory (RAM), read-only memory (ROM), electrically erasable programmable read-only memory (EEPROM), a hard disk drive or solid-state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer-readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

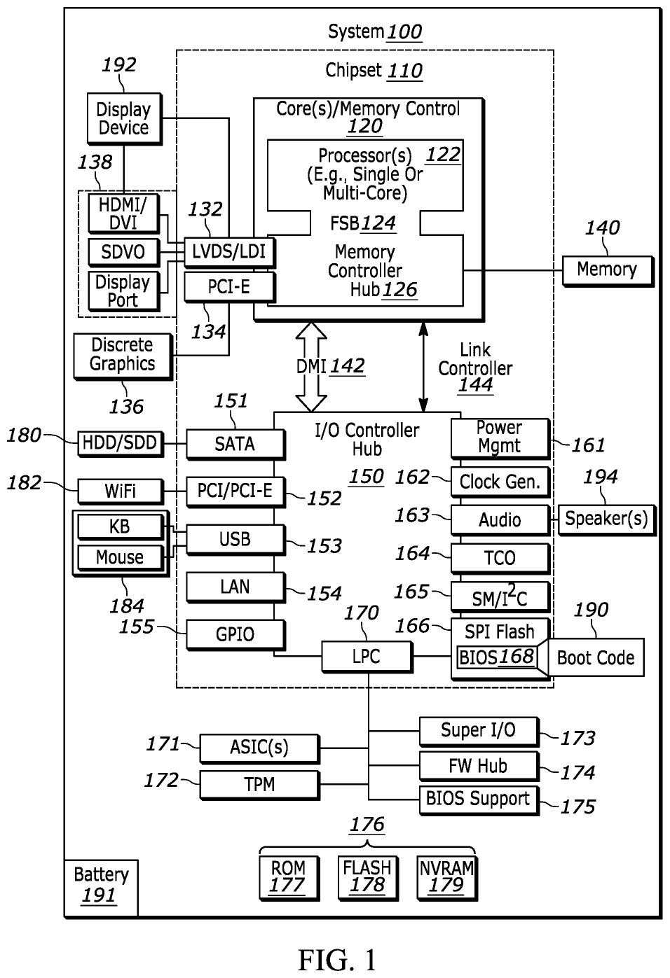

Now specifically in reference to FIG. 1, an example block diagram of an information handling system and/or computer system 100 is shown that is understood to have a housing for the components described below. Note that in some embodiments, the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized devices.

As shown in FIG. 1, system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on the brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under the direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independently of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 provides for reading, writing, or reading and writing information on one or more drives 180 such as HDDs, SDDs, or a combination thereof, but in any case the drives 180 are understood to be, e.g., tangible computer-readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice, and various other devices (e.g., cameras, phones, storage, media players, etc.).

In the example of FIG. 1, the LPC interface 170 provides for the use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include a battery 191, such as a single-cell battery or battery pack with multiple cells. In addition to containing one or more battery cells, the battery 191 may include its own one or more processors, such as a microprocessor or any other type of processor that might be provided as part of a gas gauge or battery management unit (BMU) for the battery 191. Non-transitory storage may also be included in the battery 191, with the storage storing firmware used to monitor the battery 191 and perform other functions. Random access memory (RAM) and other components may also be included in the battery 191, such as one or more sensors for sensing/measuring things related to the battery 191 and/or battery cells within, such as temperature, voltage, electric potential, age, impedance, state of charge, etc. Thus, these sensors may provide input/measurements to the processor(s) within the battery 191 and/or the processor(s) 122.

Additionally, note that one or more battery cells within the battery 191 may be configured in jellyroll format. The cells may also be configured in pouch cell format in which the strip(s) of active materials are folded or in a stacked format if desired. Regardless, the battery cells may be Lithium-ion battery cells, alkaline-based battery cells, acid-based battery cells, and/or other types of battery cells consistent with present principles.

It is to be further understood, consistent with present principles, that the battery 191 may be electrically coupled to and power the system 100, and/or individual components thereof, using battery power. The system 100, and/or battery 191 in particular, may also be electrically coupled to at least one charge receiver on the system 100 for receiving a charge via an AC/DC power supply connected to an AC power source (e.g., a wall outlet providing AC power) to charge the one or more battery cells in the battery 191. Thus, the charge receiver may include at least one circuit configured for receiving power from a wall outlet (or other AC power source) via the power supply and then providing power to the system 100 to power it and also providing power to the battery 191 to charge the cells within the battery 191. In some examples, wireless charging using a wireless charge receiver and wireless charge transmitting pad may be used.

Notwithstanding the foregoing, it is to be understood that a battery consistent with present principles need not necessarily be a smart battery as set forth above and may instead be established by one or more battery cells while not including a processor, storage, and even a charging circuit as mentioned above.

In any case, though not shown for simplicity, it is to be understood that in some embodiments the system 100 may further include a gyroscope that senses and/or measures the orientation of the system 100 and provides related input to the processor 122, an accelerometer that senses acceleration and/or movement of the system 100 and provides related input to the processor 122, and/or a magnetometer that senses and/or measures the directional movement of the system 100 and provides related input to the processor 122.

Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video.

Also, the system 100 may include a global positioning system (GPS) transceiver that is configured to communicate with satellites to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood, at least based on the foregoing, that the system 100 is configured to undertake present principles.

Moving on from FIG. 1, note consistent with present principles that each battery cell of a battery consistent with present principles may include an anode, a cathode, and an electrolyte between the anode and the cathode.

The battery may also include a casing housing the battery cell(s) and, in some examples, material coupled to an exterior of the casing. For example, the material may be disposed on, wrapped around, integrated with, or otherwise in physical contact with the battery casing (and be exposed to external elements). The material may be configured to dissolve based on chemical interaction with battery electrolyte and/or other internal matter from the battery.

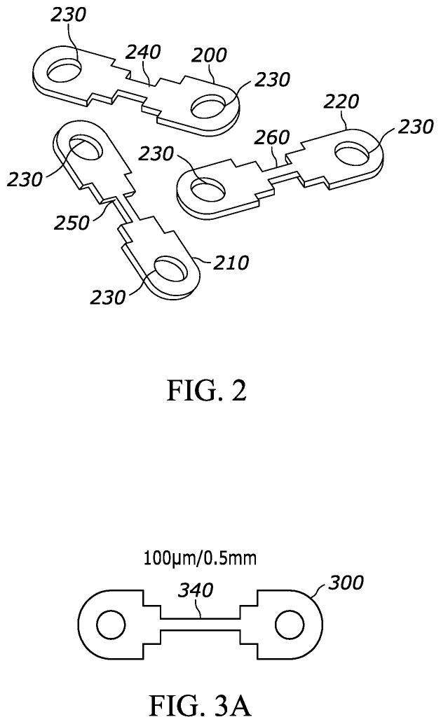

This material is shown in FIG. 2 as embodied within example fuses 200, 210, and 220. As shown in this perspective view, each fuse 200-220 is generally flat in the X-Z dimension and may be relatively thin height-wise in the Y dimension. Opposing ends/end portions (e.g., electrical terminals) of each fuse may be rigid in certain examples, electrically conductive, and include mounting holes 230 as shown to mount the respective fuse within a battery or device that houses the battery. The end portions may be made of an electrically conductive material, such as various conductive polymers and/or various metals including but not limited to aluminum, copper, and silver.

As also shown in FIG. 2, middle sections of the fuses may be rigid or pliable, electrically conductive in at least certain lengthwise sections thereof, and may each have different widths and even different heights depending on implementation. Width/height variation between 10 microns and 100 microns may be based on desired response time from when battery matter such as electrolyte (e.g., sulfuric battery acid) is first introduced to or comes into physical contact with an outer layer of the fuse and when the matter actually blows the fuse by dissolving the one or more electrically conductive layers of the middle section all the way through at one or more points as will be described further below. Demonstrating these variations depending on implementation and desired response time, middle section 240 of fuse 200 has a first width and first height, middle section 250 of fuse 210 has a second (smaller) width and second (lesser) height (faster response time), and middle section 260 of fuse 220 has a third (smallest) width and third (least) height (fastest respond time of the three).

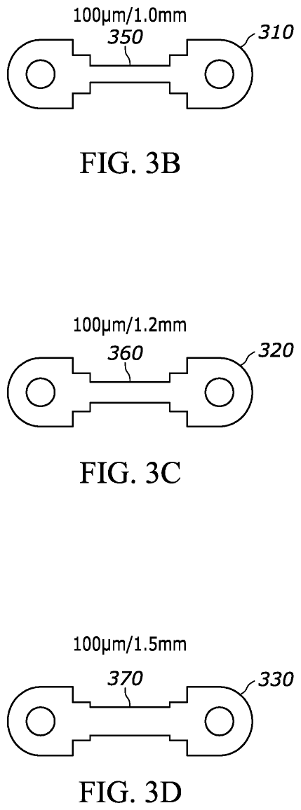

The top plan views of FIGS. 3A-3D further illustrate. Respective fuses 300, 310, 320, and 330 are shown in these figures, with a height (thickness) of 100 microns for each respective middle section 340, 350, 360, and 370. Different response times for different desired times-to-blow for each fuse may be empirically determined by a manufacturer or developer, for example, by varying the widths of the fuse. FIGS. 3A-3D therefore show that while each of the middle sections 340-370 of the example fuses 300-330 may have a same thickness in certain examples (100 microns), each may have a different width to help establish a different response time.

Fuse 300 thus has a middle section 340 with a width of 0.5 mm to establish a first response time. Fuse 310 has a middle section 350 with a greater width of 1.0 mm to establish a second response time longer than the first response time. Fuse 320 has a middle section 360 with an even greater width of 1.2 mm to establish a third response time longer than the second response time. Fuse 330 has a middle section 370 with an even greater width of 1.5 mm to establish a fourth response time longer than the third response time.

However, further note that empirical testing may also be done to vary response time based on height/thickness of the middle portions 340-370 of the respective fuses 300-330 as well. Also note that while the lengths of the middle portions 340-370 are shown as being the same in FIGS. 3A-3D, the length of a given fuse may also vary based on implementation to provide more or less coverage/potential contact area with battery electrolyte.

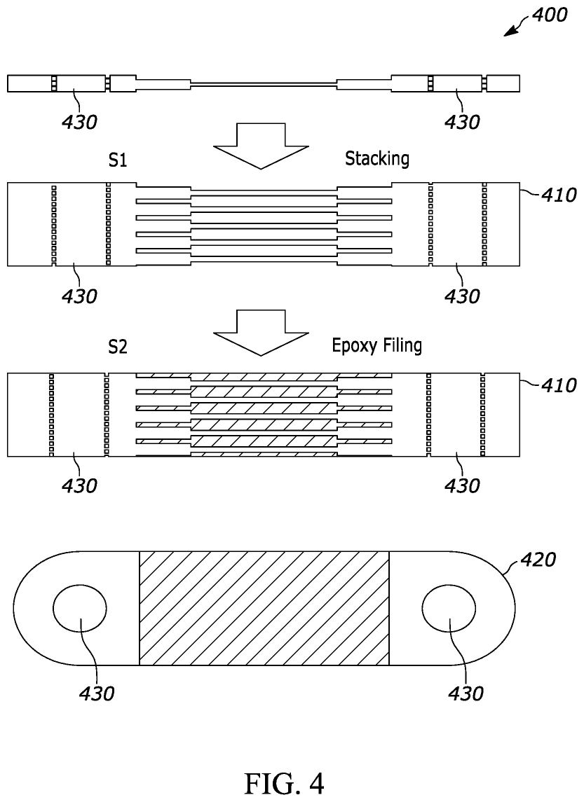

Turning to FIG. 4, assembly/manufacturing of an example fuse 400 consistent with present principles is shown. A cross-sectional view of a single-layered fuse 400 is shown at the top of FIG. 4. The single-layered fuse 400 may be manufactured as a unitary aluminum component, for example, using die casting and/or injection molding. In some example implementations, this single-layered fuse 400 may be used by itself as a fuse consistent with present principles. However, in other examples this single layer may be incorporated into a multi-layer fuse as also illustrated in FIG. 4.

Step S1 therefore shows that plural electrically conductive layers 410 may be stacked together and bound by molding, glue, welding, or other suitable materials/techniques. Step S2 then shows that vacant space between the stacked middle sections of the layers may be filled with epoxy and/or other suitable material such as nylon, nitrile, polyester, and/or cellulose as will be described further below. The vacant space may be filled with these materials, for example, through injection and/or by direct application between the layers prior to stacking together two respective layers themselves. The bottom portion of FIG. 4 then shows the fully-assembled fuse 420 in top plan view. Note that the fully-assembled fuse may also include mounting holes 430 extending vertically in the height dimension of the fuse. The holes 430 may be cylindrical or another shape and may extend through the end portions of the fuse so that the fuse can be mounted inside or outside of a battery consistent with present principles using screws or other fasteners.

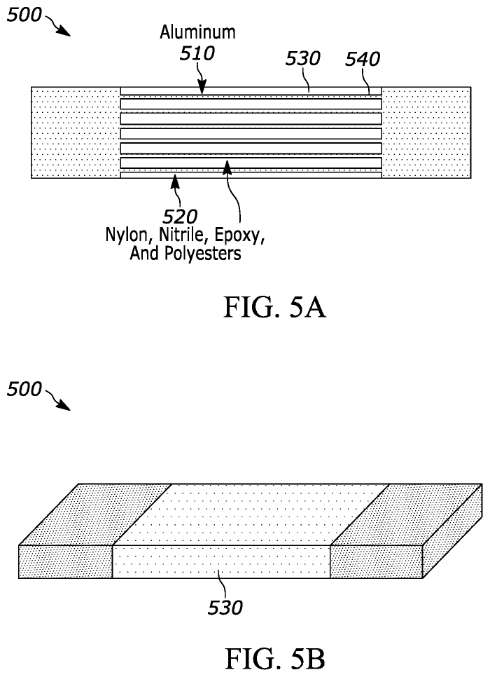

Now in reference to FIG. 5A, it shows a longitudinal cross-sectional view of an example fuse 500 that may be assembled according to the description above. Here, respective layers 510 of aluminum (illustrated in black) are adjacent to and separated by respective layers 520 of one or more of nylon, nitrite, nitrile, epoxy, and/or polyesters. These layers 510, 520 are used in this example based on the recognition that these types of materials chemically react to sulfuric acid (decompose/dissolve in the acid) as found in many lead acid-based batteries such as motor vehicle batteries. However, if the battery were alkaline-based or lithium-ion based or another type of battery, other layer suitable materials may be used for those battery chemistries so that the layer materials still break down and dissolve upon contact with the electrolyte for that respective type of battery.

In any case, note here that an outer/external, first layer 530 of the fuse 500 may be made of nylon, nitrile, and/or nitrite to provide moisture protection, preventing water (H2O) and other neutral agents from places other than the battery itself from penetrating the fuse 500 and reaching other layers of the fuse 500 insulated by the layer 530. In some examples, epoxy and/or polyesters may also be used. As also shown, aluminum establishes an insulated second layer 540, and then nylon, nitrile, nitrite, epoxy, and/or polyesters may continue establishing additional insulated layers that alternate with insulated aluminum layers as shown.

FIG. 5B then shows the assembled fuse 500 in perspective view. Note here that the fuse 500 does not have mounting holes as in the previous example embodiment. Also note per FIG. 5B that the outer/external first layer 530 encloses and insulates the middle section/inner layers of the fuse 500 (and thus all reactive layers discussed above) on all sides not already insulated by the end portions of the fuse 500.

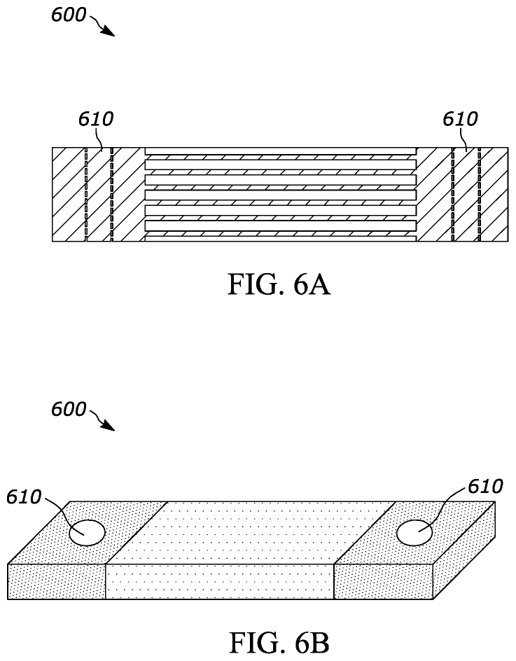

Now in reference to FIG. 6A, it shows a longitudinal cross-sectional view of another example fuse 600 consistent with present principles. The fuse 600 is also shown in perspective view in FIG. 6B. The fuse 600, including its layers, may be substantially similar to the fuse 500 described above save for mounting holes 610 being included on the end portions of the fuse 600 for mounting of the fuse 600 within a battery, external to the battery, or in a device itself that is to be powered by the battery. Also, to reiterate here, note that response time for the fuse may be varied by adjusting the width of the middle section of the fuse 600 and/or by adjusting its height (including by adding or subtracting layers including reactive layers of aluminum or other dissolvable but electrically conductible material).

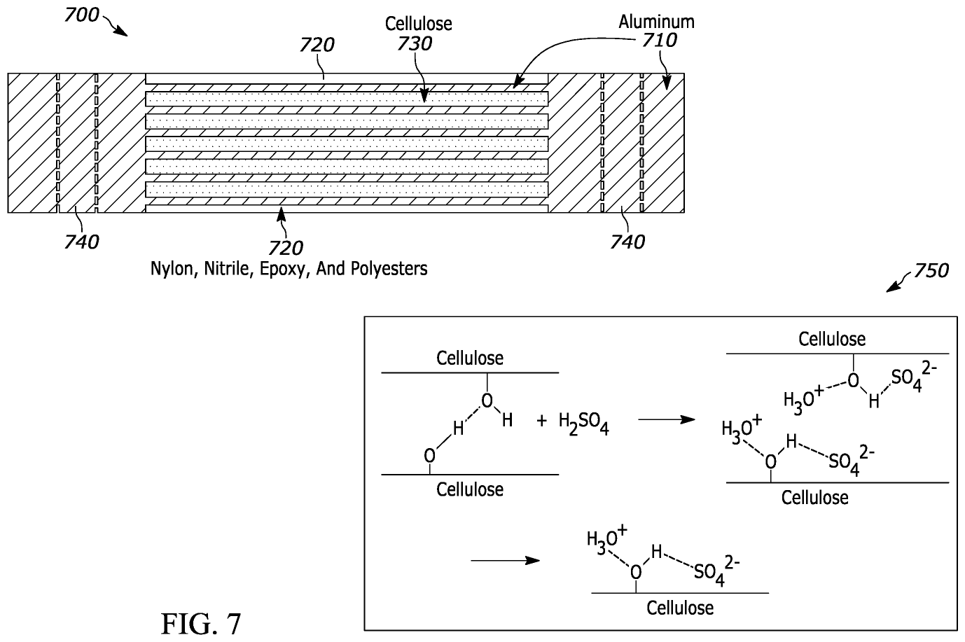

FIG. 7 shows a longitudinal cross-sectional view of another example fuse 700 that may be used consistent with present principles. The fuse 700 may be configured for an even faster response time than the fuses 500, 600, and as such may include cellulose in inner alternating layers instead of nylon, nitrile, nitrite, epoxy, and/or polyesters. Thus, while respective layers 710 may still be made of aluminum (illustrated in black) to dissolve based on sulfuric battery acid, and while an outer/external first layer 720 of the fuse 700 may still be made of nylon, nitrile, and/or nitrite to provide moisture protection (yet also dissolve when in contact with electrolyte), other adjacent and alternating inner layers 730 that alternate between the aluminum layers may be made of cellulose to dissolve even faster in sulfuric acid than nylon, nitrile, nitrite, epoxy, and polyesters. Example cellulose compositions that may be used for the layers 730 are shown in inset box 750.

FIG. 7 also shows that mounting holes 740 may also be included in this example fuse 700. Further note that just as with other example embodiments, if the associated battery with electrolyte with which the fuse 700 is to chemically interact to blow the fuse 700 were instead alkaline-based or lithium-ion based or another type of battery, other suitable reactive dissolvable layer materials may be used for those battery chemistries in place of the aluminum so that the layer materials still break down and dissolve upon contact with the electrolyte for that respective type of battery.

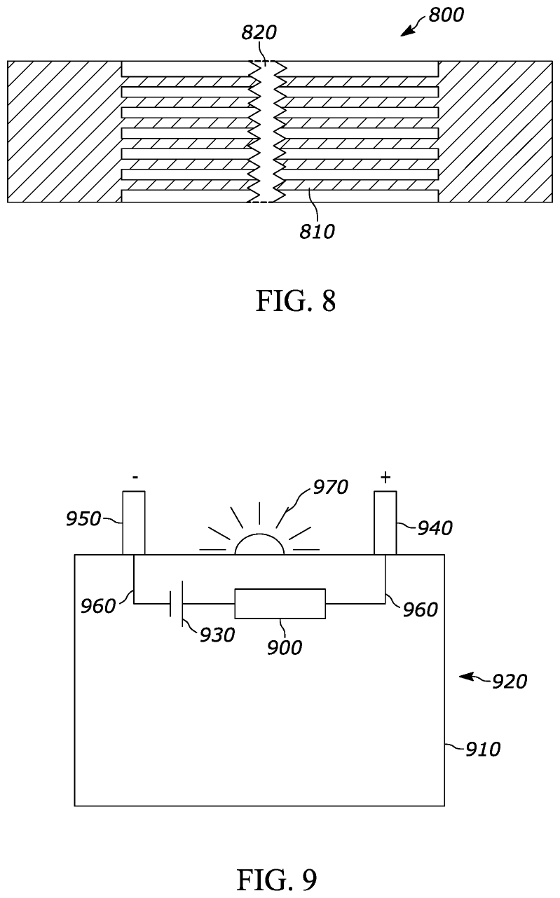

Turning now to FIG. 8, another example fuse 800 is shown, with the fuse 800 being any of the fuses 500-700 discussed above. FIG. 8 shows a longitudinal cross-sectional view of the fuse 800 after sulfuric battery acid has leaked from an acid-based battery to which the fuse 800 is coupled/mounted. As may be appreciated from FIG. 8, the acid has dissolved the layers 810 of the fuse 800 to form a hole 820 in the fuse 800 through which electric current cannot pass since the hole extends through all layers to break the continuous path of the layers (or at least forms holes in the aluminum/conductive layers), thereby blowing the fuse 800.

Note here that based on the chemical interaction with sulfuric acid, depending on implementation the fuse 800 may blow to break a current path inside the battery or to break a current path at a location external to the battery's casing but still between the battery and a device in which the battery is disposed (and powering). FIGS. 9-11 show examples of this.

Beginning first with the side elevational view of FIG. 9, a fuse 900 consistent with present principles may be disposed internal to a casing 910 of a lead acid-based, rectangular prism-shaped battery 920, with the casing 910 also housing one or more battery cells 930 in addition to the fuse 900. The cell(s) 930 may each include an anode, cathode, and electrolyte. A positive electrical battery terminal 940 and negative electrical battery terminal 950 are also shown and are in electrical communication with the cell(s) 930 to power a device in which the battery 920 is disposed.

FIG. 9 also shows that electrical lines 960 run from the terminal 940, to the fuse 900, to the cell(s) 930, and ultimately to the terminal 950 to create an electrical path for the battery to be discharged to power a device (and/or charged to charge the cells(s) 930). All of these components may therefore be in electrical communication with each other and with the device to be powered to form a complete electrical circuit for charge/discharge. Therefore, as may be appreciated from FIG. 9, should the fuse 900 blow, the circuit will be rendered incomplete and the device will no longer be able to be powered by the battery 920. This in turn may serve as a notification to the user to investigate further and potentially take correction action, while also minimizing potential damage to the battery 920 that might have caused the blown fuse 900 and that might otherwise continue to occur if the battery 920 continued to operate/power the device itself.

However, note that additional notifications may also be presented to the user responsive to the fuse 900 being blown. As an example, a light emitting diode (LED) 970 on the battery 920 itself is shown as being illuminated while the circuit is still complete (fuse 900 not blown). This LED 970 may therefore emit green light or other light of another color under normal operating conditions to indicate that the battery 920 is functioning properly. However, upon malfunction causing the fuse 900 to blow, a notification may be provided to the user via the LED 970 no longer emitting light. This may indicate that the battery 920 is “dead” and/or that a malfunction has occurred.

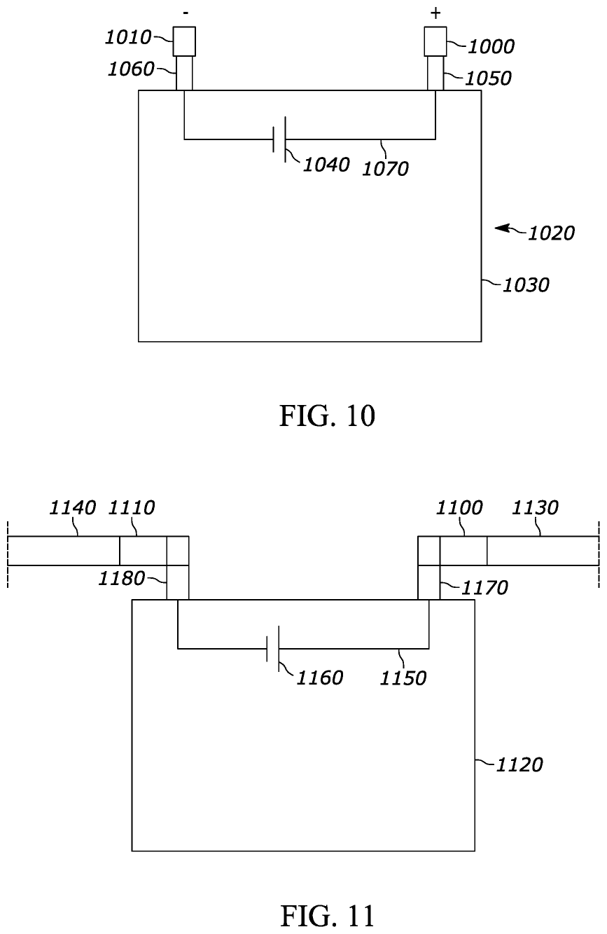

Another example is shown in the side elevational view of FIG. 10. Fuses 1000, 1010 consistent with present principles are shown. This time the fuses 1000, 1010 are still coupled to and form part of a lead acid-based battery 1020 with a casing 1030 and one or more battery cells 1040, but here the fuses 1000, 1010 are disposed external to the casing 1030 itself. In this specific example, they are disposed at distal ends/end portions of the battery's positive and negative terminals 1050, 1060. Electrical lines 1070 run from the terminal 1050, to the cell(s) 1040, and ultimately to the terminal 1060 to create an electrical path for the battery to be discharged to power a device (and/or charged to charge the cells(s) 1040).

The circuit is also formed by the fuses 1000, 1010 and device circuitry itself, and so should one or both of the fuses 1000, 1010 blow, the circuit will be rendered incomplete and the device will no longer be able to be powered by the battery 1020. This in turn may serve as a notification to the user to investigate further and potentially take correction action, while also minimizing potential damage to the battery 1020 that might have caused the blown fuse(s) and that otherwise might continue to occur if the battery 1020 continued to operate/power the device itself. Before moving on here, further note that the fuses 1000, 1010, whether disposed at distal ends of the terminals 1050, 1060 as shown or disposed at other locations external to the casing 1030, may nonetheless be disposed adjacent to and/or in close physical contact with the casing 1030 itself so that the fuse(s) may interact with battery matter such as sulfuric acid-based electrolyte that might leak out of the battery 1020 when malfunctioning or ruptured (such as leaking at locations around the terminals 1050, 1060 themselves per the example embodiment shown). Fuse location may therefore vary depending on known electrolyte release areas upon battery malfunction.

Now in reference to FIG. 11, another example is shown in side elevational view. Here, a device that houses the battery (such as a motor vehicle or other device) itself includes respective fuses 1100, 1110 that may be configured consistent with present principles. Thus, here the fuses 1100, 1110 are disposed in the device but not on the battery 1120. In this particular example, the fuses 1100, 1110 have been coupled to and/or placed in the electrical paths of electrical contacts/cables 1130, 1140 of the device itself, though they may additionally or alternatively be placed at other device locations external to the battery to nonetheless chemically interact with leaked electrolyte of the battery 1120 should it malfunction to release the electrolyte. Accordingly, here too fuse location may vary depending on known electrolyte release areas upon battery malfunction.

Electrical lines 1150 run from the positive terminal 1170, to battery cell(s) 1160, and ultimately to the negative terminal 1180 to create an electrical path for the battery 1120 to be discharged through the contacts/cables 1130, 1140 to power the device (and/or charged to charge the cells(s) 1160).

Accordingly, should one or both of the fuses 1100, 1110 blow, the circuit with the device itself will be rendered incomplete and the device will no longer be able to be powered by the battery 1120. This in turn may serve as a notification to the user to investigate further and potentially take correction action, while also minimizing potential damage to the battery 1120 that might have caused the blown fuse(s) and that otherwise continue to occur if the battery 1120 continued to operate/power the device itself.

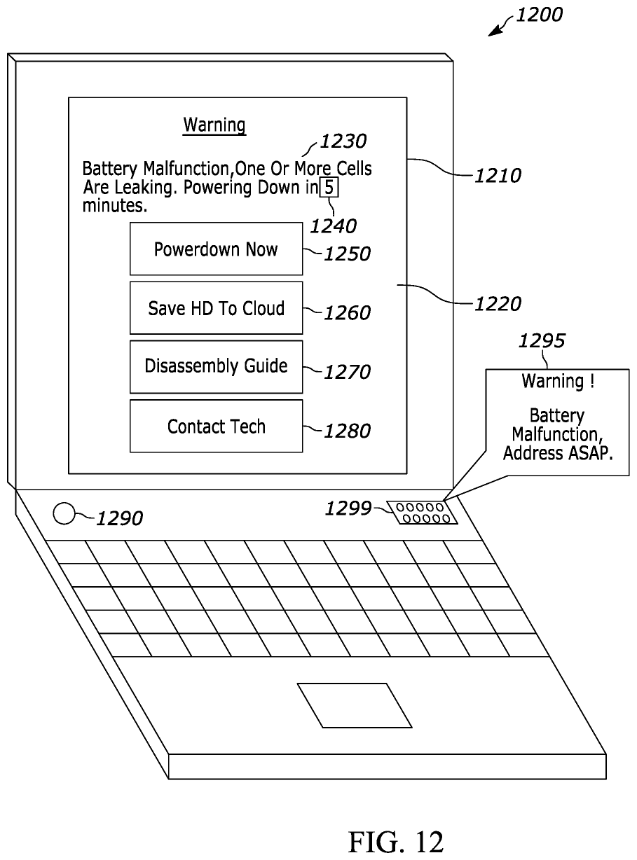

Moving on from FIG. 11, note that apparatuses/devices consistent with present principles may be configured to provide other notification types responsive to a fuse being blown as well. Other examples are therefore shown in FIG. 12, which shows a perspective view of a laptop computer 1200 that may be powered by an internal pouch cell battery with a fuse in its current path consistent with present principles. When the fuse blows, the battery's battery management unit and/or the laptop's CPU may be notified based on the current drop or other sensed metrics (e.g., while the laptop 1200 continues to be powered through an AC adapter connected to a wall electrical outlet).

One example notification that may be presented includes a graphical element presented on a display/computer monitor 1210 of the laptop 1200. In the present example, the graphical element takes the form of a graphical user interface (GUI) 1220, though in certain examples a less pronounced, smaller graphical icon or symbol may additionally or alternatively be presented.

As shown in FIG. 12, the GUI 1220 includes a prompt 1230 warning the user that a battery malfunction is occurring for the battery and that one or more cells of the battery are leaking. The prompt may also include a countdown timer 1240 indicating an amount of time remaining until the laptop 1200 autonomously shuts down to prevent further damage to itself and/or the battery, with the timer 1240 dynamically counting down from a predetermined time set by a manufacturer, system administrator, etc.

The GUI 1220 may also include various selectors that may be selectable based on touch input, cursor input, voice input, etc. to perform various associated tasks. Selector 1250 may therefore be selected to command the laptop 1200 to be powered down/fully shut off at the current time responsive to selection of the selector 1250. Or selector 1260 may be selected first instead to command the laptop 1200 to save its persistent storage/hard disk contents to a cloud storage account to which the laptop 1200 is already connected so that the user avoids losing data should the laptop 1200 be temporarily or permanently inoperable due to the battery malfunction. For example, a disk image or entire hard disk copy may be stored to cloud storage.

As also shown in FIG. 12, the GUI 1220 may include a selector 1270 that may be selected to command the device 1200 to navigate to a predetermined uniform resource locator (URL) associated with the selector 1270 through the laptop's Internet browser. The browser may then render a website retrieved using the URL to then present a laptop disassembly guide/steps to the user so that the user may determine how to remove the malfunctioning battery from the laptop 1200 before shutting down the laptop 1200 and before the malfunctioning battery becomes worse.

The GUI 1220 of FIG. 12 may also include a selector 1280. The selector 1280 may be selectable to command the device, or even a Bluetooth-paired and connected smartphone or other devices, to contact a laptop technician or even the laptop's manufacturer so that the technician/manufacturer may be made aware of the malfunction and even speak with the user through the smartphone to instruct on how to remove the malfunctioning battery. Therefore, as a specific example, selection of the selector 1280 may automatically initiate a telephone call through the user's smartphone to a predetermined number for the technician/manufacturer so that this conversation may occur even if the laptop 1200 subsequently shuts down due to the battery malfunction. Additionally or alternatively, selection of the selector 1280 may cause an auto-populated email and/or text message to be sent to the technician/manufacturer so that the technician/manufacturer may be prompted to then call the end-user on his/her smartphone to instruct the user on how to remove the laptop battery and/or other steps to take to ensure the user's safety.

Additional notifications of different types may also be presented via the laptop 1200 based on a fuse being blown or about to be blown (e.g., where the battery's BMU senses a power drop as one or more aluminum layers of the fuse are dissolved due to reaction to the leaked battery electrolyte). As one example, one of these notifications may include the illumination of a separate LED 1290 on the laptop 1200 that does not form part of the computer monitor 1210 itself. The LED 1290 may, therefore, not emit light prior to the fuse being blown but may begin emitting red or yellow light responsive to the fuse being blown to draw the user's attention to the battery malfunction.

Audio notifications may also be presented to the user. For example, an audio notification as indicated by speech bubble 1295 may be audibly presented through a laptop speaker 1299. The audible notification may indicate that the fuse has blown. In the present example, the audio notification 1295 specifically indicates in a computerized voice: “Warning! Battery malfunction, address as soon as possible.” The audio notification may indicate other items as well, such as steps to take to safely remove the malfunctioning battery, or to not handle the battery at all and to instead take the battery to a technician. An audio tone-based alarm might also be provided, such as the sound of a fire siren or even a simple repetitive beeping sound.

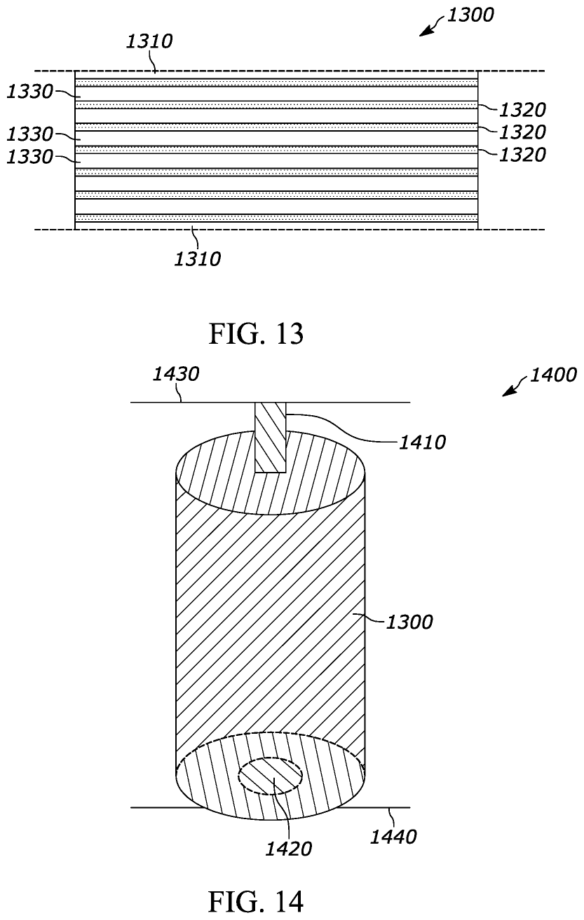

Now in reference to FIG. 13, an example is shown in cross-sectional view, where material 1300 from the middle section/layers of one of the fuses disclosed above may instead be used not in a fuse per se but as coupled to (e.g., wrapped around) an exterior of a battery's casing to still dissolve based on a chemical reaction with leaked electrolyte or other matter released from the battery upon battery malfunction. As such, the material 1300 may be configured the same as or similar to the middle portions of the fuses discussed above to still dissolve based on interaction with the matter from battery's cell(s).

Accordingly, the material may include an external first layer 1310 of nitrile, nitrite, etc. encasing/insulating the other inner layers for moisture protection. Then, similar to as also described above, the inner layers may alternate between aluminum layers 1320 as shown in black in FIG. 13 (and/or other electrically-conductive layers besides aluminum depending on battery chemistry) and layers 1330 of cellulose, nylon, nitrite, nitrile, epoxy, and/or polyesters.

FIG. 14 then shows a perspective view of a cylindrical battery 1400 with its housing/casing encased and/or insulated with the material 1300. The material 1300 is indicated via the shading that is shown. The material 1300 may be wrapped or glued on, but may additionally or alternatively be pressed into, engrained with, integrated with, or otherwise be coupled to the external surfaces of the battery's casing. But regardless, further note that at least part of the material (e.g., the aluminum) may be electrically conductive. The layers of cellulose, nitrite, etc., if not electrically conductive, may nonetheless be configured sufficiently thin so that electric current may still pass therethrough under normal operating conductions to still provide power from the battery 1400 to a device in which the battery 1400 is housed (e.g., a television remote control, a flashlight, etc.) through the battery's electrical terminals. As such, the total thickness of the material (including all layers) may be between 10 microns and 100 microns.

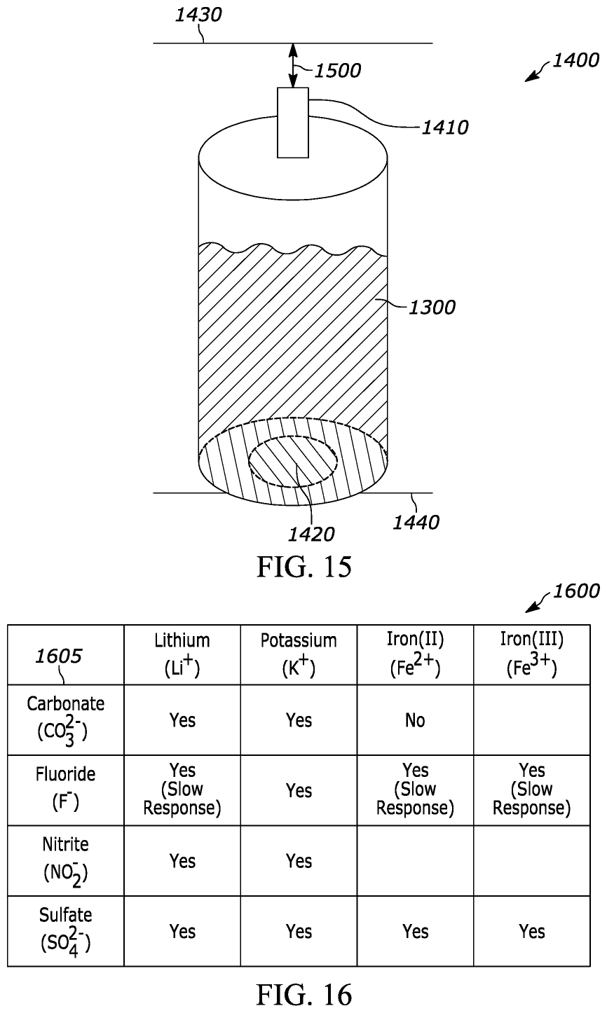

Before further describing how the material 1300 dissolves to break an electrical connection between the battery 1400 and an electrical contact 1430 or 1440 of the device in which the battery 1400 is disposed per FIG. 15, note here that the battery 1400 itself may be an AA battery, AAA battery, C battery, or D battery for example. However, other battery shapes and sizes may be similarly encased with the material 1300, including for example 9-volt batteries, electric vehicle batteries, lead-acid combustible engine-type vehicle batteries and hybrid vehicle batteries, watch/coin batteries, pouch cell batteries, etc.

Also note as shown in FIG. 14 that the material 1300 may be coupled to the exterior of the positive and negative terminals 1410, 1420 of the battery 1400 (with the terminals establishing part of the battery's casing and with the negative terminal 1420 being shown in cutaway view per FIG. 14).

Now in reference to FIG. 15, suppose the battery 1400 has malfunctioned, causing the release of electrolyte around the positive terminal 1410 of the battery 1400. This in turn may cause a chemical reaction that itself causes part of the material 1300 around the positive end of the battery 1300 to dissolve when it comes into contact with the leaked electrolyte. This may serve as a notification to the user that the battery has malfunctioned so the user can take action before the device that houses the battery is further damaged or before the malfunction poses a greater health hazard to the user.

As such, note here that the material 1300 may have one or more first colors on its exterior surface or a surface just beneath the optionally transparent nitrite/nylon outer laminate layer so that either way, the first color is appreciable with the naked eye without deconstructing any part of the material 1300 or battery 1400 itself. But when the material 1300 dissolves/disintegrates around the end as shown in FIG. 15 based on interaction with the expelled electrolyte matter, it reveals a second color (e.g., of the battery's casing) underneath it, with the second color being different from the first color(s) of the material 1300 itself. So, for example, the color of the material 1300 may be black, silver, and/or copper-colored, while the second color (e.g., of the underlying battery casing that is revealed) may be a color from the red analogous color group (e.g., red, red-orange, and/or red-violet) to draw the user's attention to the battery malfunction when the user looks at the battery 1400. And note here that the material may be painted on or integrated with the material or casing itself, for example.

What's more, the material 1300 dissolving around the terminal 1410 may create an air gap or space demonstrated by arrows 1500. This gap may be too great for the battery 1400 to maintain electrical communication with the device in which it is disposed. This in turn may cause the device itself to no longer be operable, providing another notification to the user to investigate the battery malfunction and potentially take remedial action.

Before moving on to other figures, note here that the battery 1400 may not be a lead acid-based battery and instead might be an alkaline-based or lithium ion-based battery. As such, layers of the material 1300 may be established at least in part by carbonate that might dissolve when in physical contact with an electrolyte compound, including carbon, hydrogen, and oxygen, for example.

With this in mind, note that example electrolyte solutions/solvents for lithium-based and sodium-based batteries that may be used consistent with present principles include ethylene carbonate (EC), propylene carbonate (PC), diethyl carbonate (DEC), dimethyl carbonate (DMC), dimethyl ether (DME), diethylene glycol dimethyl ether (DEGDME), tetraethylene glycol dimethyl ether (TEGDME), and 1,3 dioxolane (DOL).

Now in reference to FIG. 16, a chart 1600 indicating solubility for various example materials is shown. Column 1605 indicates different compounds that may be included in part of a dissolvable material to include in a fuse or to wrap around a battery as disclosed herein. The respective row for each entry in the column 1605 then indicates whether that respective compound is soluble or not should that material be used for electrolyte solutions/solvents containing elements indicated in the remaining columns. A “yes” designation, therefore, indicates solubility. It may be appreciated from the chart 1600 of FIG. 16 that, as indicated above, dissolvable material for wrapping or inclusion as part of a fuse may be established at least in part by carbonate so that it may dissolve when physical introduced to/chemically interacting with lithium-based electrolyte per the lithium column for example.

Moving on and now in terms of cellulose types that may be used consistent with present principles, example types include banana leaf cellulose, coir fruit cellulose, cork bark leaf cellulose, corn cob stalk cellulose, cotton seed cellulose, curaua leaf cellulose, flax stem cellulose, hardwood stem cellulose, hemp stem cellulose, jute bast cellulose, kenaf bast cellulose, maize straw cellulose, nettle bast cellulose, ramie bast cellulose, rice husk straw cellulose, softwood stem cellulose, sugar cane bagasse stem cellulose, sisal leaf cellulose, and wheat straw stalk cellulose. Algae-based cellulose (e.g., grey, green, red, and/or brown), animal-based cellulose (e.g., tunicate), and bacteria-based cellulose (e.g., gram-negative and/or gram-positive) may also be used.

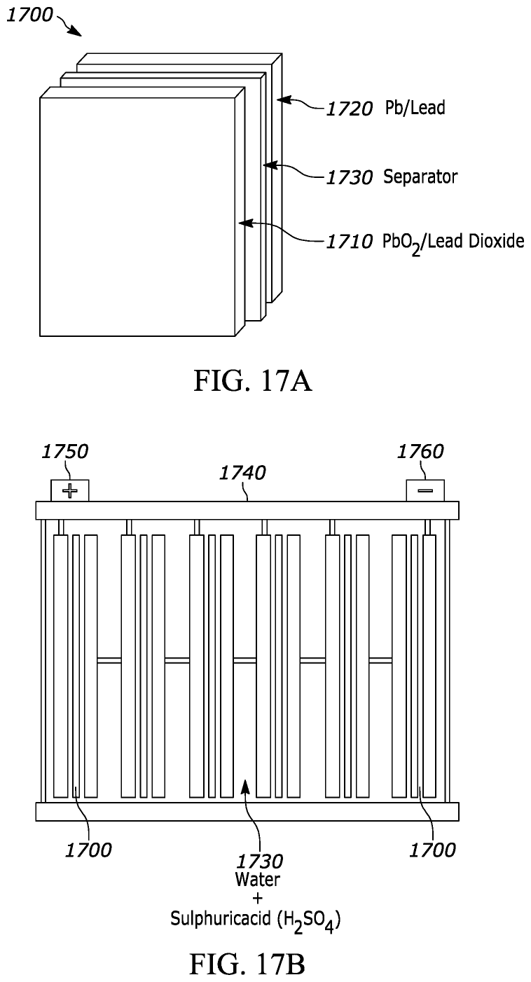

Turning now to FIGS. 17A and 17B, they show an example makeup of an example lead acid battery cell 1700 that may be used consistent with present principles, with portions thereof spaced apart in FIG. 17A for illustration. FIG. 17A thus illustrates that an example lead acid battery may be built with several individual cells (including a respective cell 1700), each containing layers of lead alloy plates 1710, 1720. Lead alloy plate 1720 (Pb) may be used for the anode, while lead alloy plate 1710 (PbO2) may be used for the cathode. FIG. 17B then shows the plates 1710 and 1720 of each respective cell 1700 immersed in an aqueous electrolyte solution 1730 and encased in a battery casing 1740. The solution 1730 may in certain specific non-limiting implementations be made of 35% sulfuric acid (H2SO4) and 65% water (H2O), though that ratio may vary if desired (e.g., with H2O still establishing a majority of the electrolyte solution). Positive and negative terminals 1750 and 1760 are also shown in communication with the cells 1700 themselves in FIG. 17B, with the cells 1700 also in electrical communication with each other.

Moving on from FIGS. 17A and 17B, note that present principles may involve methods for providing battery cells, providing casings housing the cells, and providing fuse and/or battery materials for coupling to the exteriors of battery casings as disclosed herein. The components may be provided individually, in certain sub-combinations, and/or as a fully-assembled battery. These methods may therefore include vending such batteries, manufacturing such batteries, shipping such batteries to a third party, etc.

It is to be understood that while present principals have been described with reference to some example embodiments, these are not intended to be limiting and that various alternative arrangements may be used to implement the subject matter claimed herein. Components included in one embodiment can be used in other embodiments in any appropriate combination. For example, any of the various components described herein and/or depicted in the Figures may be combined, interchanged, or excluded from other embodiments.

What is claimed is:

1. An apparatus, comprising:
a battery, the battery comprising:
at least one battery cell; and
a casing housing the at least one battery cell;
the apparatus further comprising a fuse, the fuse comprising material configured to dissolve based on chemical interaction with matter from the at least one battery cell.

2. The apparatus of claim 1, wherein based on the chemical interaction the fuse blows to break a current path inside the battery.

3. The apparatus of claim 1, wherein based on the chemical interaction the fuse blows to break a current path between the battery and a device in which the battery is disposed.

4. The apparatus of claim 3, comprising the device.

5. The apparatus of claim 1, wherein the fuse is disposed internal to the casing.

6. The apparatus of claim 1, wherein the fuse is disposed external to the casing.

7. The apparatus of claim 1, comprising a device that houses the battery, the fuse being disposed in the device but not on the battery.

8. The apparatus of claim 1, wherein the apparatus is configured to provide a notification responsive to the fuse being blown.

9. The apparatus of claim 8, wherein the notification comprises a light emitting diode (LED) on the battery no longer emitting light, the LED emitting light prior to the fuse being blown.

10. The apparatus of claim 8, wherein the notification comprises a graphical element presented on a display of a device in which the battery is disposed.

11. The apparatus of claim 8, wherein the notification comprises audio indicating that the fuse has blown.

12. The apparatus of claim 8, wherein the notification comprises illuminating a light emitting diode (LED), the LED not emitting light prior to the fuse being blown, the LED not forming part of a computer monitor.

13. The apparatus of claim 1, wherein the material comprises aluminum.

14. The apparatus of claim 13, wherein the matter comprises sulfuric acid.

15. An apparatus, comprising:
a fuse, the fuse comprising material configured to dissolve based on chemical interaction with matter from at least one battery cell.

16. The apparatus of claim 15, wherein the material comprises aluminum.

17. The apparatus of claim 16, wherein the matter comprises sulfuric acid.

18. The apparatus of claim 16, wherein the material comprises: nylon and/or nitrite in a first layer of the material, aluminum in a second layer of the material, a substance in a third layer of the material, and aluminum in a fourth layer of the material;
wherein the first, second, third, and fourth layers are different from each other, the first layer being an outer layer, the second layer being adjacent to and between the first and third layers, the third layer being adjacent to and between the second and fourth layers, the fourth layer being both adjacent to the third layer and spaced from the second layer by the third layer, the substance comprising one or more of: nylon, nitrite, cellulose.

19. The apparatus of claim 15, wherein the material has a thickness between 10 microns and 100 microns.

20. A method, comprising:
providing a battery comprising at least one battery cell; and
providing a fuse, the fuse comprising material configured to dissolve based on chemical interaction with electrolyte from the at least one battery cell.
